(19) United States
(12) Patent Application Publication
(10) Pub. No.: US 2017/0265209 A1
(43) Pub. Date: Sep. 14, 2017

(54) CONTROL APPARATUS, TERMINAL APPARATUS AND POSITION VERIFICATION SYSTEM

(71) Applicant: FUJI XEROX CO., LTD., Tokyo (JP)

(72) Inventors: Jiro MATSUDA, Yokohama-shi (JP); Takahiro SAITO, Yokohama-shi (JP); Tohru FUSE, Yokohama-shi (JP)

(73) Assignee: FUJI XEROX CO., LTD., Tokyo (JP)

(21) Appl. No.: 15/202,345

(22) Filed: Jul. 5, 2016

(30) Foreign Application Priority Data
Mar. 11, 2016 (JP) 2016-048201

(51) Int. Cl. H04W 72/12; H04W 4/02; H04W 40/24

(52) U.S. Cl. CPC H04W 72/121; H04W 40/244; H04W 4/023; H04W 88/12

(57) ABSTRACT

A control apparatus includes: a detection unit that detects a position of a terminal apparatus, based on position information acquired from a radio beacon by the terminal apparatus; an acquisition unit that acquires position verification information indicating that a position of the terminal apparatus is verified by communications with an other terminal apparatus; and an approving unit that approves a transmission request transmitted from the terminal apparatus, in a case where the acquisition unit acquires the position verification information.

### CROSS-REFERENCE TO RELATED APPLICATION

This application is based on and claims priority under 35 USC 119 from Japanese Patent Application No. 2016-048201 filed on Mar. 11, 2016.

### BACKGROUND

### (i) Technical Field

The present invention relates to a control apparatus, a terminal apparatus, and a position verification system.

### SUMMARY

A control apparatus according to a first aspect of the present invention includes a detection unit that detects a position of a terminal apparatus, based on position information acquired from a radio beacon by the terminal apparatus; an acquisition unit that acquires position verification information indicating that a position of the terminal apparatus is verified by communications with an other terminal apparatus; and an approving unit that approves a transmission request transmitted from the terminal apparatus, in a case where the acquisition unit acquires the position verification information.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a system diagram illustrating an entire configuration of a position verification system 1 according to an exemplary embodiment of the present invention;

FIG. 2 is a block diagram illustrating a hardware configuration of a terminal apparatus 10 according to the exemplary embodiment of the present invention;

FIG. 3 is a block diagram illustrating a functional configuration of the terminal apparatus 10 according to the exemplary embodiment of the present invention;

FIG. 4 is a block diagram illustrating a functional configuration of a server apparatus 12 according to the exemplary embodiment of the present invention;

FIG. 5 is a diagram illustrating an example of information which is stored in a schedule storage unit 52 of the server apparatus 12 according to the exemplary embodiment of the present invention;

FIG. 6 is a flowchart illustrating an overall operation of the position verification system according to the exemplary embodiment of the present invention;

FIG. 7 is a flowchart illustrating the details of a data transmission approving process of step 108; and

FIG. 8 is a diagram illustrating operations of terminal apparatuses 10a, 10b and 10c, and a beacon according to the exemplary embodiment of the present invention.

### DETAILED DESCRIPTION

Hereinafter, exemplary embodiments of the present invention will be described in detail with reference to the drawings.

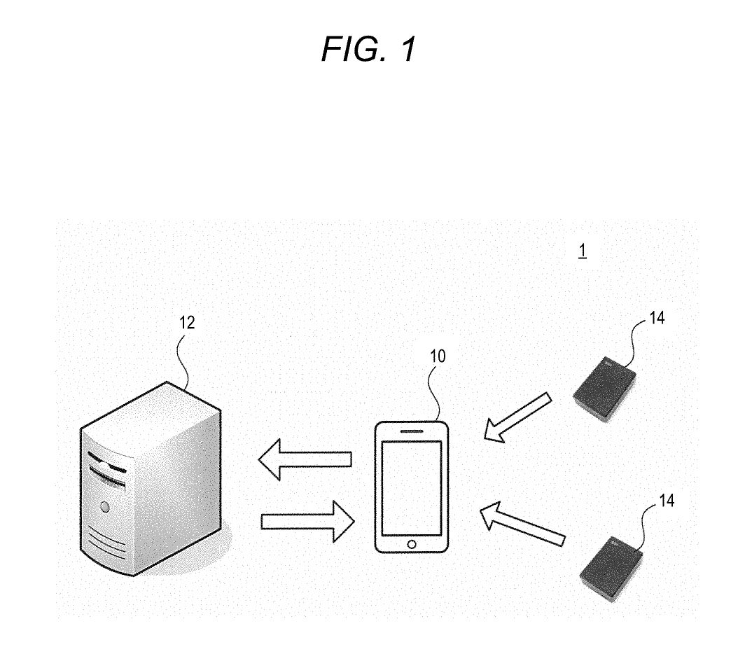

FIG. 1 is a system diagram illustrating a position verification system 1 according to an exemplary embodiment of the present invention.

The position verification system 1 according to the exemplary embodiment of the present invention, as illustrated in FIG. 1, includes a portable terminal apparatus 10 such as a personal computer, a smart phone, and a tablet terminal apparatus, a server apparatus 12 which is a control apparatus, and a beacon 14 which is a radio beacon.

Any terminal apparatus is applicable to the terminal apparatus 10 of the present invention, as long as the terminal apparatus can be connected to the server apparatus 12 through a communication network.

The terminal apparatus 10 and the server apparatus 12 are connected through a wireless LAN terminal such as a Wi-Fi router, or the Internet communication network, and thereby transmit and receive information.

The beacon 14 includes a device of generating radio waves such as Wi-Fi and is provided in a place for which position information is desired to be acquired. The beacon 14 is provided, for example, indoors such as in each conference room and always transmits radio waves (beacon information) about an ID for identifying the beacon.

In the indoor space where the beacon 14 is provided, the terminal apparatus 10 recognizes a distance from the beacon 14 based on the received signal strength indication (RSSI) of the radio waves transmitted from the beacon 14 and then transmits beacon information which is the acquired position information to the server apparatus 12 to acquire its own position information. The terminal apparatus 10 is able to perform short-range communication with other terminal apparatuses which are located within a short distance. The terminal apparatus 10 is able to receive data from the server apparatus 12 or receive a decryption key to decrypt the encrypted data.

The server apparatus 12 is used as a control apparatus that controls the terminal apparatus 10 and detects the position of a user using the terminal apparatus 10, based on the beacon information that is acquired by the terminal apparatus 10. Specifically, the server apparatus 12 acquires a beacon information output value that is received from the terminal apparatus 10, calculates a distance between the terminal apparatus 10 and the beacon 14, and specifies a beacon which is located at the nearest location so as to detect the position of the user using the terminal apparatus 10. Further, the server apparatus 12 transmits data to the terminal apparatus 10, encrypts and transmits data, limits the viewing of data by setting a disclosure period of the data, or controls the decryption of data and the disclosure of data in the terminal apparatus 10.

In the position verification system 1 according to the present exemplary embodiment, the terminal apparatus 10 acquires the radio waves of the beacon 14 provided indoors, and the terminal apparatus 10 transmits a beacon output value (received signal strength) as beacon information to the server apparatus 12. The server apparatus 12 calculates a distance between the terminal apparatus 10 and the beacon 14 based on the acquired beacon output value, specifies the beacon 14 which is located at the nearest location, and thus detects the position of the user (terminal apparatus 10). Further, based on position verification information which is acquired from the terminal apparatus 10 through short-range communication with other terminal apparatuses, the server apparatus 12 transmits data to the terminal apparatus 10, transmits a decryption key of the encrypted data, or approves the viewing of data by determining encryption and decryption of the data and the disclosure period of the data.

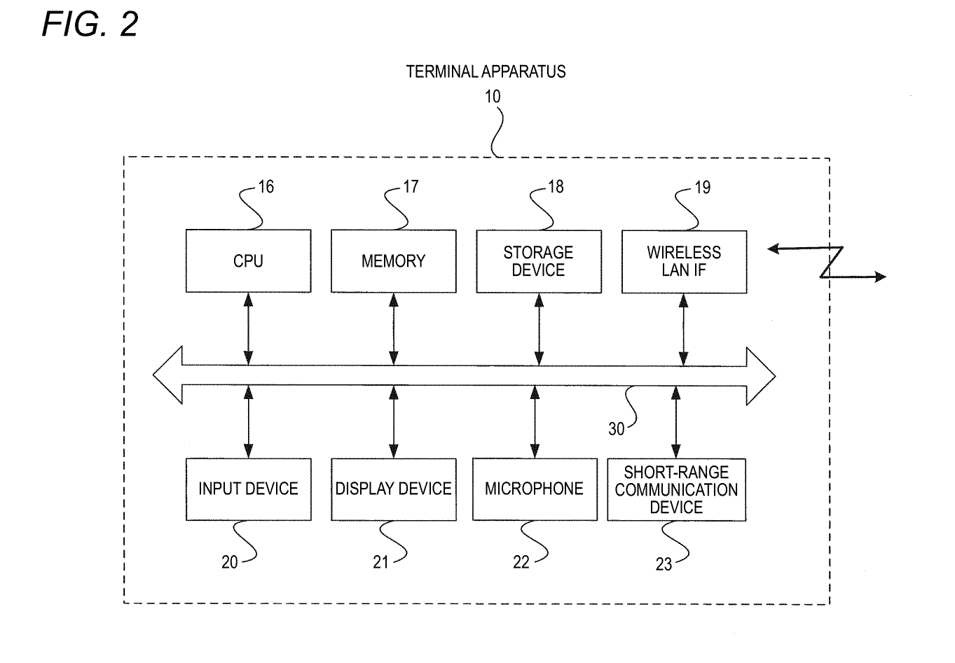

As illustrated in FIG. 2, the terminal apparatus 10 includes a CPU 16, a memory 17 capable of temporarily storing data, a storage device 18 such as a flash memory, a wireless LAN interface (IF) 19 that performs wireless communication with wireless LAN terminals to transmit and receive data, an input device 20 such as a touch sensor, a display device 21, a microphone 22, and a short-range communication device 23. Those components are interconnected through a control bus 30.

The terminal apparatus 10 according to the present exemplary embodiment is provided with a touch panel, in which a touch sensor for detecting the touch position on the display device 21 is provided as the input device 20, and input by the user is performed by the touch panel with displaying.

The CPU 16 controls the operation of the terminal apparatus 10, by executing a predetermined process based on the control program stored in the memory 17 or the storage device 18. Further, the control program can be obtained by downloading through the Internet communication network or a mobile telephone network and be provided to the CPU 16, or the control program can be stored in a recording medium such as a CD-ROM and be provided to the CPU 16 by stored.

The short-range communication device 23 transmits and receives terminal information by performing short-range communication with the terminal apparatuses 10 which are located within a short distance and transmitting and receiving data. As the short-range communication device 23, an infrared communication device that performs communication by using infrared, Bluetooth (registered trademark), a non-audible sound communication device using the microphone 22 and a speaker, or the like are used.

The terminal apparatus 10 according to the present exemplary embodiment performs an operation as described below in response to the execution of the control program, and enables, for example, the reception of data required for a conference, or the viewing of data.

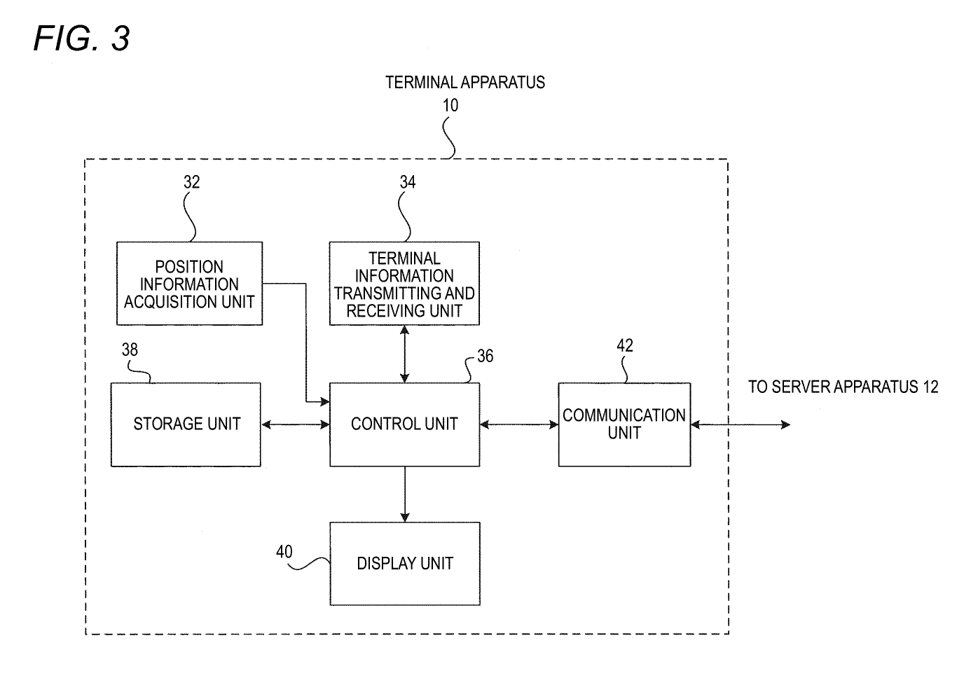

FIG. 3 is a block diagram illustrating a functional configuration of the terminal apparatus 10 which is implemented by the execution of the control program.

As illustrated in FIG. 3, the terminal apparatus 10 according to the exemplary embodiment includes a position information acquisition unit 32, a terminal information transmitting and receiving unit 34, a control unit 36, a storage unit 38, a display unit 40, and a communication unit 42.

The position information acquisition unit 32 acquires beacon information of the beacon 14 which is provided in the proximity of the terminal apparatus 10.

The terminal information transmitting and receiving unit 34 communicates with other terminal apparatuses which are within a short distance, by using the short-range communication device 23, and transmits and receives each terminal information.

The storage unit 38 stores various types of data which are received from the server apparatus 12.

The display unit 40 performs display of various types of data, based on the control by the control unit 36.

The communication unit 42 performs communication with the server apparatus 12 which is an external device.

The control unit 36 transmits the position information which is acquired by the position information acquisition unit 32 to the server apparatus 12 through the communication unit 42. Further, the position verification information, which is acquired by the terminal information transmitting and receiving unit 34 that found other terminal apparatuses within a short distance from the terminal apparatus 10, is transmitted to the server apparatus 12 through the communication unit 42.

Further, the control unit 36 performs control so as to display the position information and the acquired position verification information on the display unit 40.

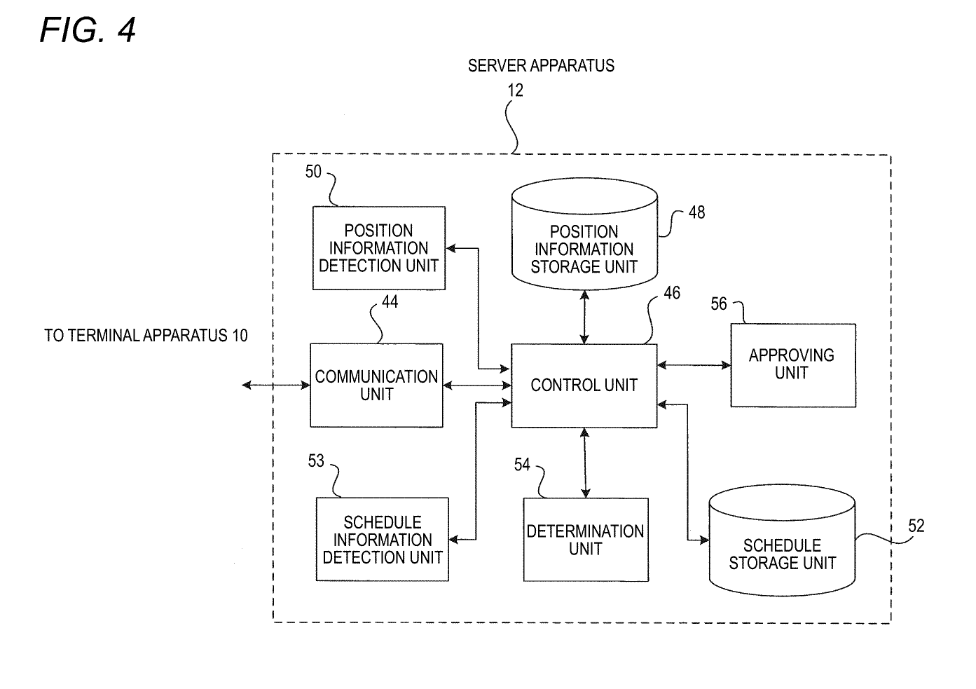

Next, the functional configuration of the server apparatus 12 according to the present exemplary embodiment of the present invention will be described with reference to the block diagram of FIG. 4.

According to FIG. 4, the server apparatus 12 according to the present exemplary embodiment includes a communication unit 44, a control unit 46, a position information storage unit 48, a position information detection unit 50, a schedule storage unit 52, a schedule information detection unit 53, a determination unit 54, and an approving unit 56.

The position information storage unit 48 stores information about the output values (received signal strengths) of plural beacons 14.

The position information detection unit 50 calculates a distance between the terminal apparatus 10 and the beacon 14, based on the beacon output value (received signal strength) that the terminal apparatus 10 acquires, and specifies a beacon 14 which is located at the nearest location among plural pieces of beacon information which are stored in the position information storage unit 48 to detect the position (place) of the terminal apparatus 10.

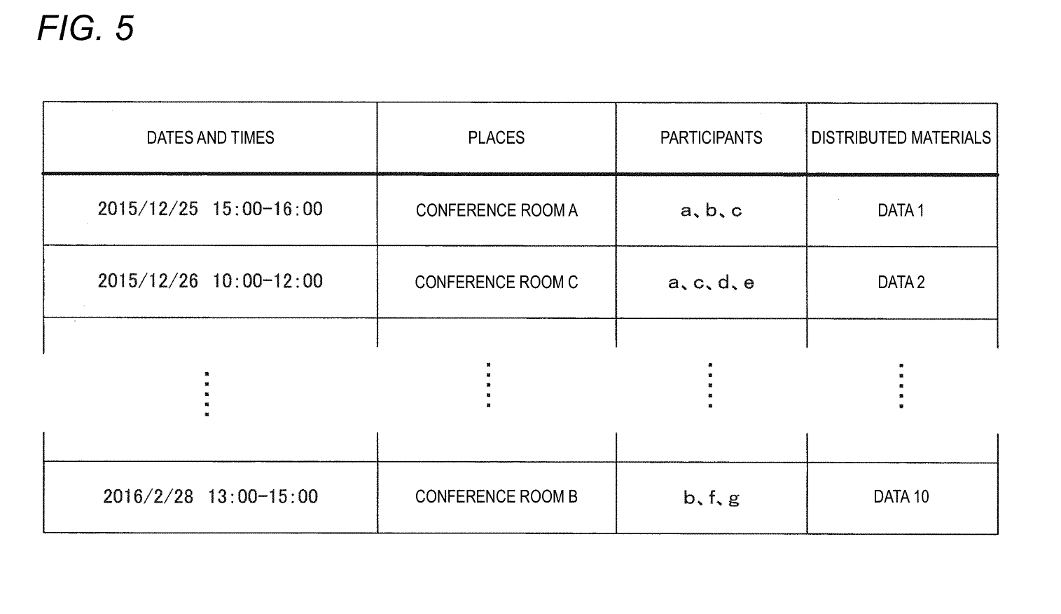

As illustrated in FIG. 5, the schedule storage unit 52 stores plural pieces of information such as dates and times, locations, participants, and distributed materials. The date and time is stored as time information, the place is stored as position information, and the participant is stored as the terminal information of the terminal apparatus 10 that the participant uses.

The schedule information detection unit 53 detects schedule information at a date and a time at which the terminal apparatus 10 accesses the server apparatus 12, based on the time information (the date and the time in FIG. 5) which is stored in the schedule storage unit 52, from the date and the time.

The determination unit 54 determines whether or not the position information (the place in FIG. 5) of the schedule information, which is detected by the schedule information detection unit 53, is coincident with the position information, which is acquired from the terminal apparatus 10. Further, the determination unit 54 determines whether or not the terminal information of the terminal apparatus 1 acquired as the position verification information is present in the terminal information (the participant in FIG. 5) of the detected schedule information.

In a case where the determination unit 54 determines that the acquired position information is coincident with the position information of the schedule information or determines that the acquired position information is coincident with the position information of the schedule information and a case where there is terminal information of a terminal apparatus which is verified based on the position verification information, among plural pieces of the terminal information of the schedule information, the approving unit 56 approves the transmission of data of schedule information. The approving unit 56 approves the transmission of a decryption key to decrypt the encrypted data and approves the viewing of data having viewing restriction.

In addition, although the present exemplary embodiment has described an example in which data is stored in the schedule storage unit 52 as schedule information, it is not limited thereto. A data storage unit may be provided in the server apparatus 12, plural pieces of data to be transmitted to the terminal apparatus 10 may be stored in the data storage unit, and the transmission of data which is requested from the terminal apparatus 10 may be approved. In addition, plural pieces of data include encrypted data.

In a case where the position information is acquired from the terminal apparatus 10, the control unit 46 controls to calculate the position information based on the plural pieces of data which are stored in the position information storage unit 48, detects the position of the terminal apparatus 10, and thus transmits the position to the terminal apparatus 10 through the communication unit 44. Further, the control unit 46 controls the approving unit 56 to permit the transmission of data, based on the acquired position information or position verification information, and controls to transmit data to the terminal apparatus 10 through the communication unit 44, transmits a decryption key of the encrypted data, or releases the viewing limit of data to enable the viewing of the data.

Next, the operation of the position verification system 1 according to the exemplary embodiment of the present invention will be described in detail.

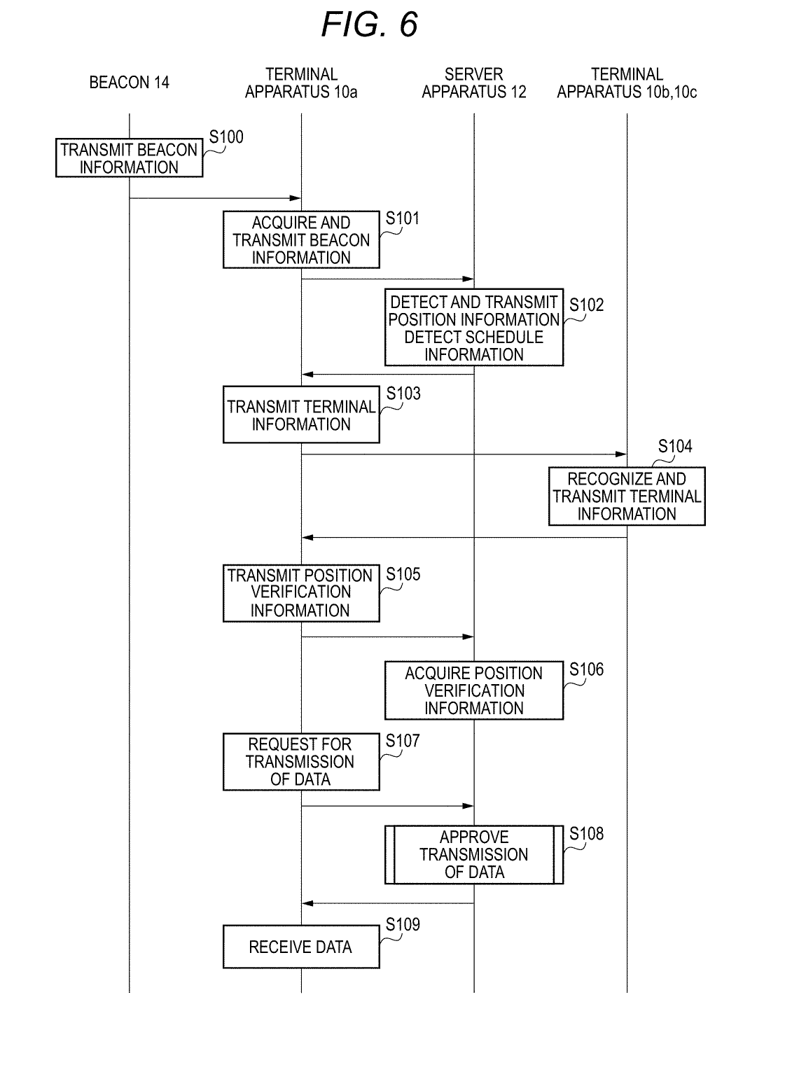

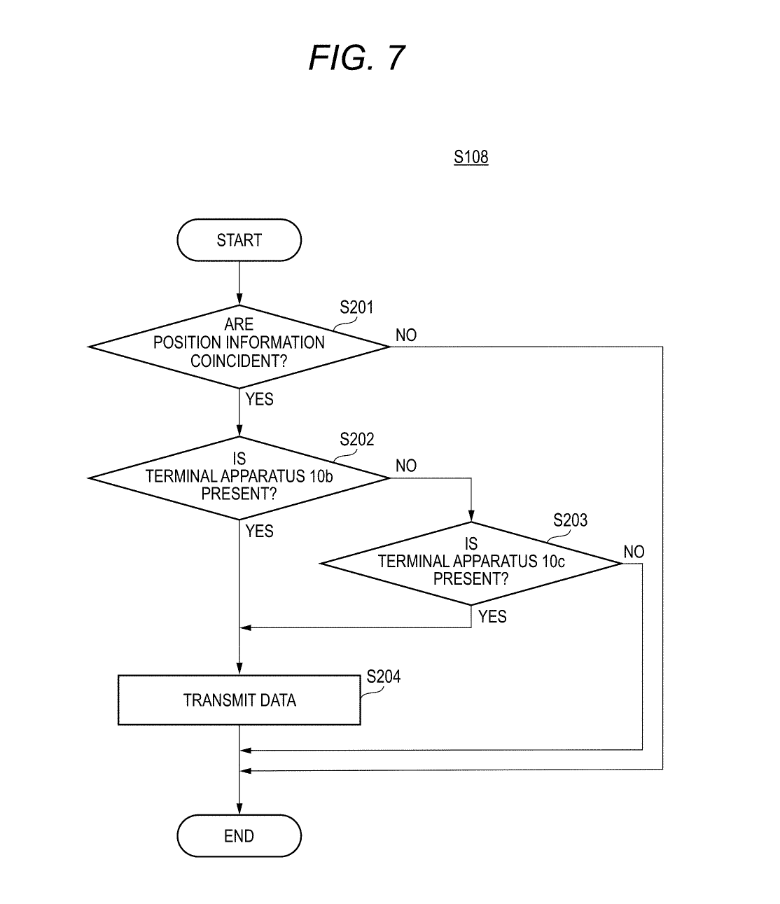

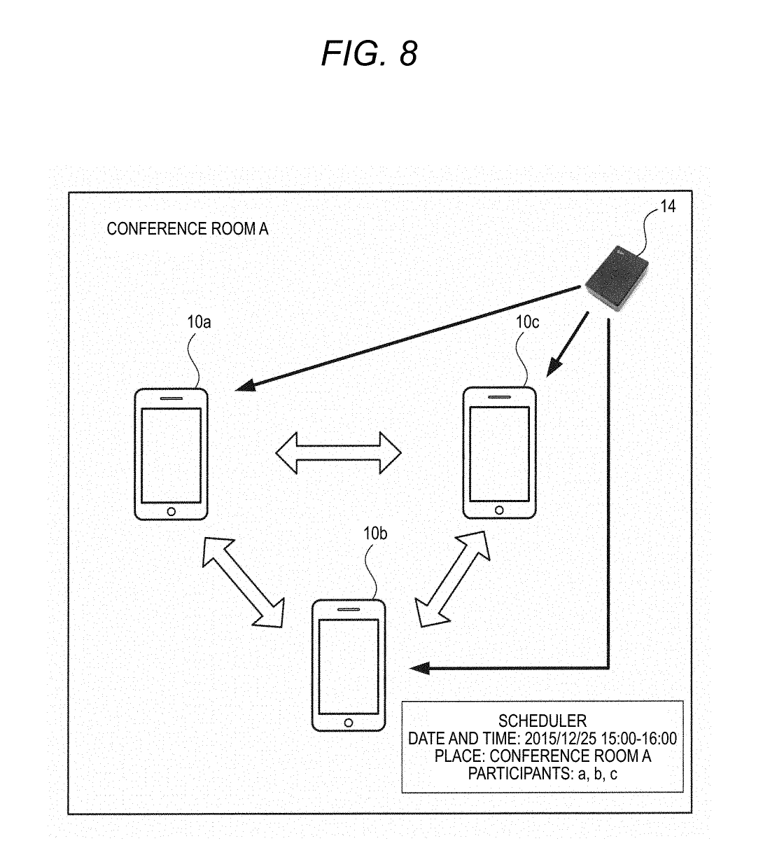

FIG. 6 is a flowchart illustrating the operation of the position verification system 1 according to the exemplary embodiment of the present invention. FIG. 7 is a flowchart illustrating the details of a data transmission approving process of step 108. FIG. 8 is a diagram illustrating the operations of terminal apparatuses 10a, 10b, and 10c and the beacon 14 in the conference room A. In the present exemplary embodiment, the operation of the position verification system 1 will be described, with a case of respectively transmitting data 1 which is distributed material in a conference, which is held at the conference room A, 2015/12/25 15:00-16:00, participants a, b, and c, among schedule information of FIG. 5 from the server apparatus 12 to the terminal apparatuses 10a, 10b, and 10c of the participants a, b, and c, as an example. The beacon 14 is provided in the conference room A. In addition, FIG. 6 is focused on the operation of the terminal apparatus 10a, and since the configurations and operations of the terminal apparatus 10b and the terminal apparatus 10c are those of the terminal apparatus 10a, the decryption thereof will be omitted.

In step 100 (S100), the beacon 14 always transmits radio waves (beacon information) about an ID for identifying the beacon.

In step 101 (S101), the terminal apparatus 10a transmits the beacon information which is acquired from the beacon 14, to the server apparatus 12.

In step 102 (S102), the server apparatus 12 calculates the position information based on the beacon information which is received from the terminal apparatus 10a, detects the position of the terminal apparatus 10a by using the position information detection unit 50, and transmits the detected position to the terminal apparatus 10a. The schedule information detection unit 53 detects schedule information, based on the time information (2015/12/25 15:00-16:00 in the present exemplary embodiment) which is stored in the schedule storage unit 52, from a date and a time at which the terminal apparatus 10a accesses the server apparatus 12.

Next, in step 103 (S103) and step 104 (S104), as illustrated in FIG. 8, the terminal apparatuses 10a, 10b, and 10c in the conference room A perform the short-range communication by using the respective short-range communication devices 23. Specifically, the terminal apparatus 10a transmits its own terminal information to the other terminal apparatus 10b and terminal apparatus 10c in the conference room A (S103). The terminal apparatus 10b and the terminal apparatus 10c transmit a notification that the terminal information of the terminal apparatus 10a is recognized (S104).

In step 105 (S105), since it is recognized that the terminal apparatus 10a is located within a short distance from the terminal apparatus 10b and the terminal apparatus 10c w in the conference room A, the terminal apparatus 10a transmits position verification information to the server apparatus 12.

In step 106 (S106), the server apparatus 12 acquires the position verification information from the terminal apparatus 10a.

In other words, after the server apparatus 12 acquires the beacon information and the schedule information of each of the terminal apparatuses 10a, 10b, and 10c which are in the conference room A, the terminal apparatuses 10a, 10b, and 10c, which are used by the participants a, b, and c included in the schedule information, perform the short-range communication such as infrared communication to transmit and receive the terminal information with each other, and exchange data with each other, such that it is verified that the terminal apparatus 10a is close to other terminal apparatuses which are used by participants of a conference in the conference room A, and the position information which is acquired from the beacon 14 is verified to be correct. In other words, the position information of the participant which receives the terminal information in the conference room A is specified by performing short-range communication, and the authenticity of position information is guaranteed.

Then, in step 107 (S107), the terminal apparatus 10a makes a request for transmitting the data which is distributed material for a conference stored in the schedule storage unit 52, to the server apparatus 12.

In step 108 (S108), the server apparatus 12 determines whether or not the transmission of the requested data is approved. Step 108 (S108) will be described in detail.

In step 201 (S201), it is determined whether or not the position information detected in step 102 (S102) is coincident with the position information (the conference room A in the present exemplary embodiment) of the schedule information detected in step 102 (S102). If it is determined that the position information are coincident with each other, the process proceeds to next step 202 (S202); and if it is determined that both of the position information are not coincident with each other, the process is ended (the transmission of data to the terminal apparatus 10a is not approved).

In step 202 (S202), it is determined whether or not the terminal information of the terminal apparatus 10b, which is acquired as the position verification information in step 106 (S106), is present in the terminal information of the schedule information which is detected in step 102 (S102). In a case where the terminal information of the terminal apparatus 10b is present in the terminal information of the schedule information, the process proceeds to next step 204 (S204), the transmission of data is approved, and data is transmitted to the terminal apparatus 10a. In a case where the terminal information of the terminal apparatus 10b is not present in the terminal information of the schedule information, the process proceeds to next step 203 (S203).

In step 203 (S203), it is determined whether or not the terminal information of the terminal apparatus 10c, which is acquired as the position verification information in step 106 (S106), is present in the terminal information of the schedule information which is detected in step 102 (S102). In a case where the terminal information of the terminal apparatus 10c is present in the terminal information of the schedule information, the process proceeds to next step 204 (S204), the transmission of data is approved, and data is transmitted to the terminal apparatus 10a. In a case where the terminal information of the terminal apparatus 10c is not present in the terminal information of the schedule information, the process is ended (the transmission of data to the terminal apparatus 10a is not approved).

In other words, if the position information are coincident with each other and if the terminal information is present in the terminal information of the schedule information, the transmission of data is approved. The transmission of a decryption key to decrypt the encrypted data is approved, or the viewing of data having viewing restriction is approved.

In step 109 (S109), the terminal apparatus 10a receives data which is approved based on each of position verification information.

In addition, although the exemplary embodiment has described an example in which data is transmitted from the server apparatus 12 to the terminal apparatus 10 in a case where the transmission request is approved, it is not limited thereto. A decryption key to decrypt encrypted data which is already transmitted may be transmitted, or the viewing limit or the editing limit applied to the data in the server apparatus 12 may be released.

It should be noted that the present invention is not limited to the above exemplary embodiment, and various modifications are possible.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control apparatus comprising:
a detection unit that detects a position of a terminal apparatus, based on position information acquired from a radio beacon by the terminal apparatus;
an acquisition unit that acquires position verification information indicating that a position of the terminal apparatus is verified by communications with an other terminal apparatus; and
an approving unit that approves a transmission request transmitted from the terminal apparatus, in a case where the acquisition unit acquires the position verification information.

2. The control apparatus according to claim 1, further comprising:
a schedule information detection unit that detects schedule information including time information, position information, and terminal information, which are associated with an event,
wherein the approving unit approves the transmission request transmitted from the terminal apparatus, in a case where the detected position of the terminal apparatus is coincident with the position information of the schedule information which is detected by the schedule information detection unit.

3. The control apparatus according to claim 2,
wherein the approving unit approves the transmission request transmitted from the terminal apparatus, in a case where terminal information which is acquired as the position verification information is included in terminal information of the schedule information which is detected by the schedule information detection unit.

4. A terminal apparatus comprising:
a first transmitting unit that transmits position information which is acquired from a radio beacon;
a second transmitting unit that transmits position verification information indicating that a position of the terminal apparatus is verified by communications with an other terminal apparatus; and
a reception unit that receives data, transmission of which is approved based on the position verification information that is transmitted by the second transmitting unit.

5. A position verification system comprising:
a beacon;
a terminal apparatus; and
a control apparatus,
wherein the terminal apparatus includes
a first transmitting unit that transmits position information which is acquired from the beacon;
a second transmitting unit that transmits position verification information indicating that a position of the terminal apparatus is verified by communications with an other terminal apparatus; and
a reception unit that receives data, transmission of which is approved based on the position verification information that is transmitted by the second transmitting unit, and
wherein the control apparatus includes
a detection unit that detects a position of the terminal apparatus, based on position information that is transmitted by the first transmitting unit;
an acquisition unit that acquires the position verification information that is transmitted by the second transmitting unit; and
an approving unit that approves a data transmission request transmitted from the terminal apparatus, in a case where the acquisition unit acquires the position verification information.
